(19) United States
(12) Patent Application Publication
(10) Pub. No.: US 2026/0062530 A1
(43) Pub. Date: Mar. 5, 2026

(54) POLYARYLETHERKETONE (PAEK) GELS AND AEROGELS

(71) Applicant: VIRGINIA TECH INTELLECTUAL PROPERTIES, INC., Blacksburg, VA (US)

(72) Inventors: Robert Bowen MOORE, Blacksburg, VA (US); Glenn Allen SPIERING, Blacksburg, VA (US); Michelle Elizabeth POMATTO, Carlisle, PA (US)

(21) Appl. No.: 19/319,993

(22) Filed: Sep. 5, 2025

Related U.S. Application Data
(60) Provisional application No. 63/691,030, filed on Sep. 5, 2024.

(51) Int. Cl. C08J 9/28; B33Y 80/00; C08J 3/075

(52) U.S. Cl. CPC C08J 9/28; B33Y 80/00; C08J 3/075; C08J 2201/0484; C08J 2205/022; C08J 2205/026; C08J 2329/12

(57) ABSTRACT

Polyaryletherketone aerogels. In particular, a method of making polyaryletherketone aerogels using environmentally benign solvents for gel formation. In addition, a method is provided for 3D printing of such polyaryletherketone aerogels. The polyaryletherketone aerogels may specifically be sourced from poly(ether ether ketone) (PEEK) or poly(ether ketone ketone) (PEKK).

### FIELD

The present invention is directed to polyaryletherketone gels and aerogels. In particular, a method of making polyaryletherketone gels and aerogels using environmentally benign solvents for gel formation. In addition, a method is identified for 3D printing of such polyaryletherketones aerogels. The polyaryletherketone gels aerogels may specifically be sourced from poly(ether ether ketone) (PEEK) or poly(ether ketone ketone) (PEKK).

### BACKGROUND

Polymeric gels are known to contain a polymeric network that is said to exhibit solid-like behavior while physically retaining liquids or gases within their three-dimensional macromolecular framework. The gel network can be held together with covalent chemical bonds, as in the case of crosslinked gels, or by physical interactions, in the case of physical gels. The physical interactions that compose a physical gel network can include hydrogen bonding, helix formation, phase separation, polymer entanglements, ionic aggregation, π-π interactions, and polymer crystallites. Physical gels are also described as thermoreversible, as their physical interactions are thermally labile.

Thermoreversible gelation has been reported for poly(vinyl chloride), polyethylene, isotactic polypropylene, syndiotactic polystyrene, poly(L-lactic acid), polyoxymethylene, polyamide-6, poly(vinylidene fluoride), poly(ethylene terephthalate), poly(phenylene oxide), syndiotactic poly(methyl methacrylate) and poly(phenylene sulfide). The choice of solvent reportedly leads to differences in gel morphology and properties.

When the solvent in a gel network is replaced with a gas (e.g. air), it is understood to be an aerogel. Evaporative drying, freeze-drying, and supercritical fluid extraction are reportedly utilized for removing the solvent from a gel. Aerogels so produced reportedly have relatively low density, relatively high porosity, relatively high surface area, and relatively low thermal conductivity.

Accordingly, one object herein is to provide a method of making polyaryletherketone gels and aerogels with, e.g., improved mechanical properties and a method of making polyaryletherketone gels and aerogels, based upon the use of what can be described as an environmentally benign solvent, such as 1,3-diphenylacetone (DPA).

### SUMMARY

A method of forming a polyaryletherketone gels and aerogels comprising supplying a polyaryletherketone, supplying 1,3-diphenylacetone solvent and combining the polyaryletherketone and 1,3-diphenylacetone solvent. This is then followed by heating to form a solution of the polyaryletherketone in 1,3-diphenylacetone solvent. The solution is then cooled with formation of a polyaryletherketone gel. The polyaryletherketone gel so formed in 1,3-diphenylacetone can then undergo solvent exchange with replacement of the 1,3-diphenylacetone with an aliphatic alcohol or acetone solvent. This is then followed by replacement of the aliphatic alcohol or acetone solvent with water and then the gel can be lyophilized to remove water, resulting in the polyaryletherketone aerogel. In addition, the polyaryletherketone gel containing aliphatic alcohol or acetone solvent may undergo supercritical CO₂ extraction to form the aerogel. The polyaryletherketone may preferably be selected from poly(ether ether ketone) or poly(ether ketone ketone).

A method of 3D printing a polyaryletherketone aerogel comprising supplying a polyaryletherketone, supplying a solvent for said polyaryletherketone that has a boiling point of at or greater than 300° C., and combining the polyaryletherketone and solvent and heating to form a solution of the polyaryletherketone in the solvent. This is followed by cooling the solution and forming a solvated polyaryletherketone in the presence of the solvent and forming pellets of the solvated polyaryletherketone gel. The pellets of the solvated polyaryletherketone gel are then fed into an extruder followed by extruding one or more layers of the solvated polyaryletherketone gel. One can then replace the solvent in the solvated polyaryletherketone gel with an aliphatic alcohol or acetone followed by: (1) replacement of the aliphatic alcohol or acetone solvent with water and forming a polyaryletherketone hydrogel where the polyaryletherketone hydrogel is lyophilized to remove water; or (2) removal of the aliphatic alcohol or acetone solvent via supercritical CO₂ extraction with formation of the polyaryletherketone aerogel.

### BRIEF DESCRIPTION OF THE DRAWINGS

FIG. 1 is a scanning electron micrograph (SEM) of a 15.0% wt. PEEK aerogel gelled in 1,3-diphenylacetone at 10 kX magnification.

FIG. 2 is a scanning electron micrograph (SEM) of a region identified in FIG. 1.

FIG. 3 is a plot of the level of crystallinity in the PEEK aerogel versus the PEEK content (wt. %) in the DPA solution that was utilized to form the aerogel.

FIG. 4 shows the pore size distribution for the PEEK aerogels gelled in DPA at a solution concentration in the range of 8.0% (wt.) PEEK in DPA to 22.0% (wt.) PEEK in DPA.

### DETAILED DESCRIPTION

The polyaryletherketone (PAEK) polymers that are suitable here for the preparation of an aerogel are contemplated to include semi-crystalline polymers having at least one aromatic group (—Ar—) and at least one ketone group (—CO—) and at least one ether group (—O—) in the polymeric repeat unit. Typical of the polyaryletherketone polymers is the aromatic poly(ether ketone) or PEK. PEK has the following general repeating unit structure, wherein n is an integer and identifies the number of repeating units, which can range from 50-300:

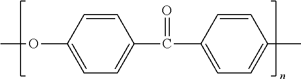

Another example of a polyaryletherketone includes poly(ether ether ketone) or PEEK, which has the following general structure, where n is an integer and again preferably has a value between 50-300:

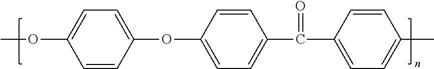

A still further example of a polyaryletherketone includes poly(ether ether ketone ketone) which has the following general structure, wherein again n is an integer any may have a value in the range of 50-300:

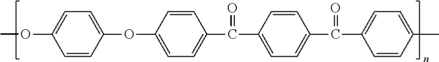

Yet another example of a polyaryletherketone herein includes poly(ether ketone ketone) which has the following general repeating unit structure, where n is an integer and can have a value in the range of 50-300:

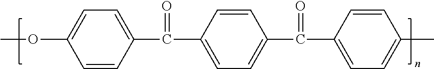

The molecular weight of all the preferred polyaryletherketones noted above are such that the value of n in the repeating unit also preferably provides a number average molecular weight (Mn) in the range of 10,000 to 100,000.

The polyaryletherketones herein are initially combined with an environmentally benign solvent which upon heating forms a solution of the polyaryletherketone polymer, followed by cooling and gelation, a solvent exchange step, and ultimately removal of solvent and formation of the polyaryletherketone aerogel. The environmentally benign solvent is selected from 1,3-diphenylacetone (DPA) which has a melting point of 34° C., a boiling point of 330° C., and which is identified as an FDA-approved food grade additive. The structure of DPA is set out below:

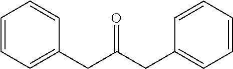 [SMILES: O=C(Cc1ccccc1)Cc1ccccc1]

As alluded to above, the initial step is to provide the polyaryletherketone polymer and mix with the solvent DPA. By way of preferred example in the case of PEEK as the exemplary polyaryletherketone, one prepares a PEEK/DPA solution at a preferred polymer concentration in the range of 5.0% (wt.) to 50.0% (wt.), including all individual values and increments therein. More preferably, the PEEK/DPA solution is prepared at a polymer concentration in the range of 8.0% (wt.) to 22.0 wt. %. In addition, such PEEK/DPA solution is preferably prepared by heating the mixture of PEEK and DPA to a dissolution temperature of 310° C. to 330° C. More preferably, the PEEK/DPA solution is heated to a temperature of 320° C., +/−5° C. It is worth noting that during the preparation of the PEEK/DPA solution, it has been found preferable to ensure that one mechanically agitates or stirs the PEEK/DPA mixture upon heating and from the point that the DPA melts up to the selected dissolution temperature. Such stirring upon heating has been observed to provide a relatively more homogenous aerogel with relatively uniform mechanical properties.

The PEEK/DPA solution so prepared is then subject to cooling to induce gelation. The gel so formed may be understood as a solvated gel, containing phase separated polymer in the DPA solvent. Cooling is preferably achieved by taking the heated PEEK/DPA solution and pouring into open-ended cylindrical glass tubes, which are preferably held in a well heater, and set to a desired cooling temperature. A preferred cooling temperature is 50° C., +/−10° C. The cylindrical glass tubes preferably have a nominal inner diameter of 9.0 mm and a length of 100 mm. Gelation was observed to occur after a period of about 5.0 minutes, and the total cooling time was allowed to take place for a preferred period of 15.0 minutes to 30.0 minutes, most preferably for a period of 20 minutes, +/−2.0 minutes.

After the preferred gelation time of 20.0 minutes, the PEEK/DPA gels, still within the tubes, is subject to solvent exchange. Preferably, this is achieved by placing the PEEK/DPA solvated gels in an ethanol bath to exchange the DPA solvent with an aliphatic alcohol, such as ethanol or acetone. After about 24 hours, the ethanol or acetone is then preferably exchanged with fresh ethanol or acetone, and the gels are removed from the tubes. After a further time of about 24 hours in the ethanol or acetone bath, the gels were transferred to a Soxhlet extractor to further replace any residual DPA with ethanol or acetone. Soxhlet extraction was carried out for a preferred period of about 4 days. The ethanol or acetone-soaked gels are then exchanged with deionized water for about 4 days in a water bath. The water is preferably replaced with fresh deionized water on a daily basis. The hydrogels so obtained are then preferably frozen overnight and then preferably lyophilized (sublimation of the residual water) over about 24 hours to yield a freeze-dried PEEK aerogel. It is also worth noting that one can take the ethanol or acetone-soaked gels noted above and utilize supercritical CO₂ extraction procedures to remove the ethanol to again provide the aromatic polyketone aerogel.

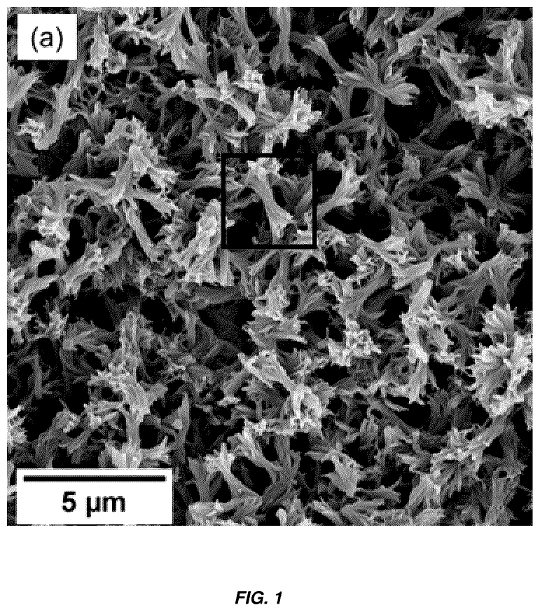

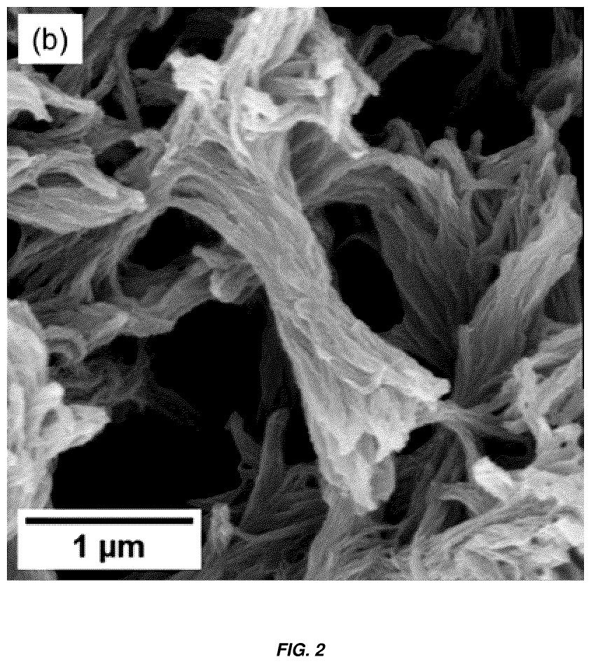

FIG. 1 is a scanning electron microscopy (SEM) micrograph of a 15.0% (wt.) PEEK aerogel gelled in DPA at 10 kx magnification. FIG. 2 is at 20 kx magnification. The location shown in the box in FIG. 1 is shown in FIG. 2. As can be seen, PEEK aerogels gelled in DPA appear to contain a network of struts (connecting structures) of relatively uniform size. The struts appear elongated and have branching and splaying at their ends, which is consistent with premature spherulites, or axialites.

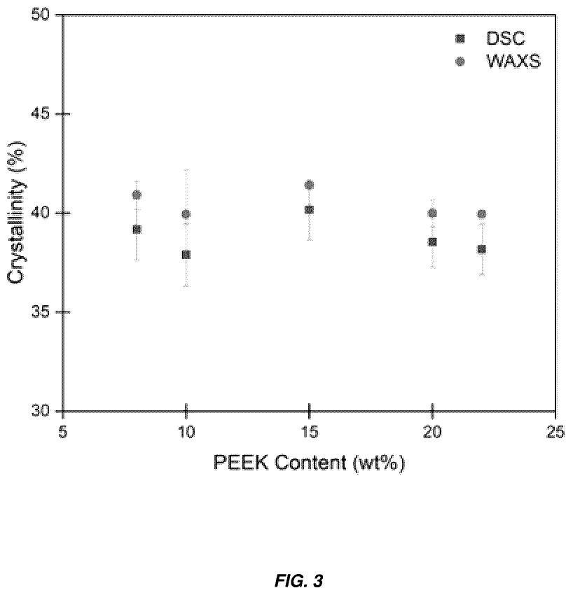

PEEK aerogels so produced were characterized for the various physical and mechanical properties. Crystallinity of the PEEK aerogels gelled in DPA were determined by both DSC (integrations of DSC melting endotherms) and wide-angle x-ray (WAXS) analysis. FIG. 3 illustrates the level of crystallinity of the PEEK aerogel versus the PEEK content (wt. %) in the DPA solution utilized to form the aerogel. As can be seen, the observed level of crystallinity of the PEEK aerogels fall within the range of 35.0% to 45.0%. The levels of crystallinity measured by WAXS were observed to be higher as compared to DSC determinations.

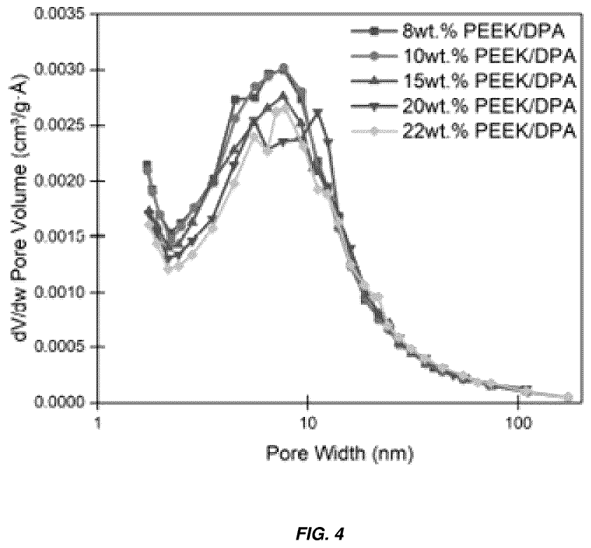

FIG. 4 shows the pore size distribution for the PEEK aerogels gelled in DPA, at a solution concentration in the range of 8.0 wt. % PEEK in DPA to 22.0 wt. % PEEK in DPA. Pore size was determined by nitrogen absorption isotherms by applying the Barret-Joyner-Halenda (BJH) method. See, Barret, E. P., Joyner, L. G., Halenda, P. P., J. Am Chem. Soc. 1951, 73, 373-380. The pore width varied in the range of about 2.0 nm to 105 nm. The maximum width of the pores appeared to be 7.5 nm +/−0.5 nm. In addition, the densities of the PEEK aerogels were observed to preferably fall in the range of 0.09 g/cm³ to 0.50 g/cm³. Finally, compression testing of the PEEK aerogels indicated a modulus of compression over the range of 5.0 MPa (at an density of 0.1 g/cc) to 90 MPa (at a density of 0.4 g/cc to 0.5 g/cc).

It is also contemplated herein that the polyaryletherketone aerogels may be prepared via additive manufacturing and 3D printed via a selective extrusion of a polyaryletherketone gel preferably through a direct ink write (DIW) system. A DIW system is reference to an extrusion based 3D printing technique in which a liquid feedstock of selected viscosity is dispensed through nozzles under a selected pressure and flow rate. Initially, to prepare the feedstock for printing via a DIW system, a polyaryletherketone, as described herein, is dissolved in a relatively high boiling solvent. A relatively high boiling solvent herein is a solvent that indicates a boiling point of at or greater than 300° C. Accordingly, DPA may be preferably utilized since it indicates a boiling point of 330° C., and as noted above, it is listed as an FDA food grade additive.

The PAEK aerogels herein were also evaluated for their thermal conductivity. Specifically, steady-state thermal conductivity measurements were performed using a Calibrated Hot Plate Thermal Conductivity Analyzer developed by Aerogel Technologies Inc. (Boston, MA), following ASTM Standard E1225 [2009]. In this setup, the aerogel sample (of unknown thermal conductivity) and a National Institute of Standards and Technology (NIST) reference material with known thermal conductivity (expanded polystyrene board, NIST SRM 1453 are placed in series between a hot plate (set at 37.5° C.) and a cold plate (set at 0° C.). See, Zarr, R. and Pintar, A. (2012), Standard Reference Materials: SRM 1453, Expanded Polystyrene Board, for Thermal Conductivity from 281 K to 313 K, Special Publication (NIST SP), National Institute of Standards and Technology, Gaithersburg, MD, [online], https://doi.org/10.6028/NIST.SP.260-175 (Accessed Jul. 9, 2025). Assuming one-dimensional heat transfer under steady-state conditions, the thermal conductivity of the aerogel (k_{aerogel}) is calculated using the following equation:

$${k}_{aerogel} = {k}_{NIST} \frac{Δ {T}_{INST}}{Δ {T}_{aerogel}} \frac{{t}_{aerogel}}{{t}_{NIST}} ,$$

where, k_{NIST} is the thermal conductivity of the reference material (NIST SRM 1453, with a bulk density of 0.048 g/cm³ and a room temperature thermal conductivity of 35.6 mW/mK), and ΔT_{NIST}, ΔT_{aerogel}, t_{NIST}, and t_{aerogel} are the temperature differences and the thicknesses of the NIST standard sample and the aerogel specimen, respectively. See, S. A. Steiner, et al. (2023). Recipes and Designs for Aerogels. In: Aegerter, M. A., Leventis, N., Koebel, M., Steiner III, S. A. (eds) Springer Handbook of Aerogels. Springer Handbooks. Springer, Cham. https://doi.org/10.1007/978-3-030-27322-4_65. The PAEK aerogels herein were therefore determined to have a thermal conductivity in the range of 20 mW/m*K to 40 mW/m*K.

Therefore, as disclosed herein, the polyaryletherketone is combined into the relatively high boiling solvent followed by heating to form a solution of the polyaryletherketone in the relatively high boiling solvent, of which DPA is preferred. The solution is again cooled with formation of the solvated polyaryletherketone gel (polyaryletherketone gel phase in the relatively high boiling solvent). This solvated polyaryletherketone gel can now be broken into pellet size pieces that are contemplated to serve as a gel feedstock. The pellet size pieces, which preferably have a longest cross-sectional dimension in the range of 3.0 mm to 5.0 mm, may then be loaded into a heated extruder where the temperature is raised to form a liquid feedstock suitable for printing. With application of pneumatic pressure, the liquid may be extruded through one or a plurality of nozzles and deposited on a print substrate. The extrudate will then cool at which point it reverts back to form the solvated polyaryletherketone gel. The extrudate so cooled is contemplated to have sufficient viscosity to maintain its printed shape including the capability of supporting additional printed layers as a selected part geometry is then built on a selected substrate. After printing, the part can undergo solvent exchange with replacement of the relatively high boiling solvent with an aliphatic alcohol or acetone solvent, followed by replacement of the aliphatic alcohol or acetone solvent with water and then the printed part can be lyophilized to remove water to provide the 3D printed polyaryletherketone aerogel. In addition, it is contemplated that the aliphatic alcohol or acetone solvent in the 3D printed polyaryletherketone may be removed by supercritical CO₂ extraction.

1. A method of forming a polyaryletherketone gel comprising:
a. Supplying a polyaryletherketone;
b. supplying 1,3-diphenylacetone solvent;
c. combining said polyaryletherketone and 1,3-diphenylacetone solvent and heating to form a solution of said polyaryletherketone in said 1,3-diphenylacetone solvent;
d. cooling the solution and forming a solvated polyaryletherketone gel in the presence of said 1,3-diphenylacetone solvent.

2. The method of claim 1, wherein said solvated polyaryletherketone gel undergoes solvent exchange and replacement of said 1,3-diphenylacetone with an aliphatic alcohol or acetone solvent.

3. The method of claim 2, wherein said aliphatic alcohol or acetone solvent is replaced with water and providing a polyaryletherketone hydrogel.

4. The method of claim 3, wherein said polyaryletherketone hydrogel is lyophilized to remove water to provide a polyaryletherketone aerogel.

5. The method of claim 2, wherein said aliphatic alcohol or acetone solvent is removed by supercritical CO₂ extraction to form a polyaryletherketone aerogel.

6. The method of claim 1, wherein said polyaryletherketone comprises poly(ether ketone) having the following repeating unit structure, where n is an integer:

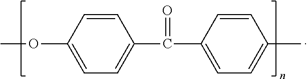

7. The method of claim 1, wherein said polyaryletherketone comprises poly(ether ether ketone) having the following repeating unit structure where n is an integer:

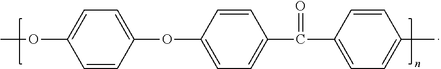

8. The method of claim 1, wherein said polyaryletherketone comprises poly(ether ether ketone ketone) having the following repeating unit structure where n is an integer:

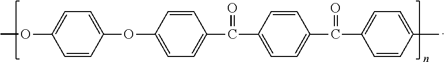

9. The method of claim 1, wherein said polyaryletherketone comprises poly(ether ketone ketone) having the following repeating unit structure where n is an integer:

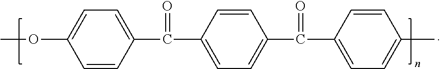

10. The method of claim 1, wherein said polyaryletherketone is combined with said 1,3-diphenylacetone at a level in the range of 5.0% (wt.) to 50.0% (wt.).

11. The method of claim 1, wherein heating in step (c) comprises heating to a temperature in the range of 310° C. to 330° C.

12. The method of claim 4, wherein said polyaryletherketone aerogel has a density in the range of 0.09 g/cc to 0.50 g/cc.

13. The method of claim 4, wherein said polyaryletherketone aerogel indicates a compression modulus in the range of 5.0 MPa to 90.0 MPa.

14. The method of claim 5, wherein said polyaryletherketone aerogel has a density in the range of 0.09 g/cc to 0.50 g/cc.

15. The method of claim 5, wherein said polyaryletherketone aerogel indicates a compression modulus in the range of 5.0 MPa to 90.0 MPa.

16. The method of claim 1, wherein said polyaryletherketone aerogel indicated a thermal conductivity in the range of 20 mW/m*K to 40 mW/m*K.

17. A method of 3D printing a polyaryletherketone aerogel comprising:
a. supplying a polyaryletherketone;
b. supplying a solvent for said polyaryletherketone that has a boiling point of at or greater than 300° C.;
c. combining said polyaryletherketone and solvent and heating to form a solution of said polyaryletherketone in said solvent;
d. cooling the solution and forming a solvated polyaryletherketone gel in the presence of said solvent;
e. forming pellets of said solvated polyaryletherketone gel
f. feeding said pellets of said solvated polyaryletherketone gel into an extruder and extruding one or more layers of said solvated polyaryletherketone gel;
g. replacing said solvent in said solvated polyaryletherketone gel with an aliphatic alcohol or acetone solvent followed by: (1) replacement of said aliphatic alcohol or acetone solvent with water and forming a polyaryletherketone hydrogel where said polyaryletherketone hydrogel is lyophilized to remove water; or (2) removal of said aliphatic alcohol or acetone solvent via supercritical CO₂ extraction with formation of the polyaryletherketone aerogel.
